(19) United States
(12) Patent Application Publication
(10) Pub. No.: US 2026/0180870 A1
(43) Pub. Date: Jun. 25, 2026

(54) NETWORK MODIFICATION SIMULATION IN COMMUNICATION NETWORKS

(71) Applicant: AT&T Intellectual Property I, L.P., Atlanta, GA (US)

(72) Inventor: Satya B. Vardharajan, San Diego, CA (US)

(73) Assignee: AT&T Intellectual Property I, L.P., Atlanta, GA (US)

(21) Appl. No.: 18/990,473

(22) Filed: Dec. 20, 2024

(51) Int. Cl. H04L 41/16; G06F 16/3329; H04L 41/14

(52) U.S. Cl. CPC H04L 41/16; H04L 41/145; G06F 16/3329

(57) ABSTRACT

Aspects of the subject disclosure may include, for example, receiving data about a communications network, based on the data about the communication network, adjusting weights of a neural network to represent a state of the communications network, and training a large language model, the large language model incorporating the neural network, the large language model being selected to be domain specific to the communications network, providing, to the large language model, a network modification for simulation, wherein the network modification comprises one or more changes to the communications network to modify structure or function of the communications network, receiving, from the large language model, an indication that the network modification yields a stable network state when the network modification is applied to the communications network, and providing, to the large language model, an approval of an implementation of the network modification, wherein the approval of the implementation of the network modification causes the large language model to automatically modify one or more components of the communications network at a selected time to implement the network modification. Other embodiments are disclosed.

### FIELD OF THE DISCLOSURE

The subject disclosure relates to a system and method for simulating a modification to a communication network prior to implementing a safe modification in the communications network.

### BACKGROUND

Communication systems play a role in connecting businesses, enterprises, and campuses to their customers and each other. These systems are necessary for secure, reliable, and high-performance operations. Operators need to deeply understand their systems to ensure continuous and smooth operations. The increasing number and types of devices, along with advancements in computing and AI, add significant complexity to system management and maintenance.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C is a block diagram illustrating an example, non-limiting embodiment of a system functioning within the communication network of FIG. 1 in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system that automates and streamlines network maintenance and upgrades by leveraging detailed network data and artificial intelligence. The system uses a neural network and a large language model to simulate network modifications, assess their impacts, and provide recommendations, ensuring stable and secure operations. This approach significantly reduces manual effort and minimizes the risk of unplanned outages, enhancing the overall efficiency and reliability of the communications network. Other embodiments are described in the subject disclosure.

One or more aspects of the subject disclosure include a device that includes a processing system with a processor and memory. This device collects data about a communications network, adjusts the weights of a neural network to represent the network's state, and trains a large language model (LLM) specific to the communications network. Aspects of the subject disclosure further include a device that simulates network modifications, assesses the network stability, and, upon approval, automatically implements the modifications at a selected time.

One or more aspects of the subject disclosure include a non-transitory machine-readable medium containing executable instructions. When executed by a processing system, these instructions facilitate operations such as collecting network data, adjusting neural network weights, simulating network modifications, assessing the results, and implementing the modifications based on the simulation outcomes.

One or more aspects of the subject disclosure include a method that includes receiving data about a communications network, adjusting the weights of a neural network to represent the network's state, and simulating a proposed network modification using a large language model that incorporates a neural network. The method also involves receiving and evaluating the simulation results to ensure the proposed modification yields a stable network state.

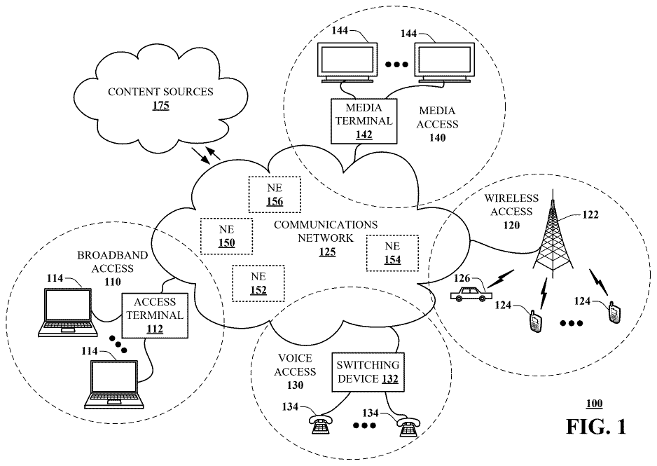

Referring now to FIG. 1, a block diagram is shown illustrating an example, non-limiting embodiment of a system 100 in accordance with various aspects described herein. For example, system 100 can facilitate in whole or in part using a neural network and a large language model to simulate network modifications, assess their impacts, and provide recommendations, ensuring stable and secure operations. Embodiments can be implemented within the system 100 depicted in FIG. 1, which includes various network elements (NEs) 150, 152, 154, 156 that facilitate broadband access 110, wireless access 120, voice access 130, and media access 140. A platform can be integrated into this system 100 to automate and streamline maintenance and upgrade processes in the system. By leveraging detailed network data from access terminals 112, network element 150 and associated connectivity links, base stations or access points 122, switching devices 132, and media terminals 142, the platform can simulate network modifications, assess their impacts, and provide recommendations to ensure stable and secure operations. This allows for an AI based comprehensive validation and reduces the manual effort required by network operators and minimizes the risk of unplanned outages.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Communication systems such as the communications network 125 play a role in connecting businesses, enterprises, and campuses to their customers and each other. These systems are necessary for secure, reliable, and high-performance operations. Operators need to deeply understand their systems to ensure continuous and smooth operations.

Periodically, network maintenance, reconfiguration and modification in such a communication network are required. The increasing number and types and versions of devices, hardware, software, and firmware variations, network functionality, supported services, configuration and security policies along with advancements in computing and AI, add significant complexity to network management and maintenance. Administrators face immense pressure to maintain uptime, requiring teams of highly skilled engineers to meticulously plan and execute maintenance, repair, and upgrade activities. This process involves collecting and studying detailed state information for the communications network 125 and its component elements through various audits, designing and testing maintenance activities in a lab, and conducting risk assessments and then developing a step-by-step procedure for the change. Such activities must be completed before the actual implementation of a change to the communications network. This resource-intensive and time-consuming process does not scale well as system size and complexity grow.

Currently, network maintenance involves writing, peer-reviewing, and risk-assessing maintenance procedures before implementation. Maintenance windows are scheduled, and pre-checks and post-checks are conducted to ensure the network state is preserved across changes. If undesirable impacts occur, procedures are rolled back, and root cause analyses are conducted to revise the maintenance procedure. This conventional manual process is arduous, time-consuming, and prone to errors, making the process challenging to scale and maintain large, complex systems. There is a need for a streamlined, efficient, and scalable solution to simplify maintenance and reduce the risk of unplanned outages.

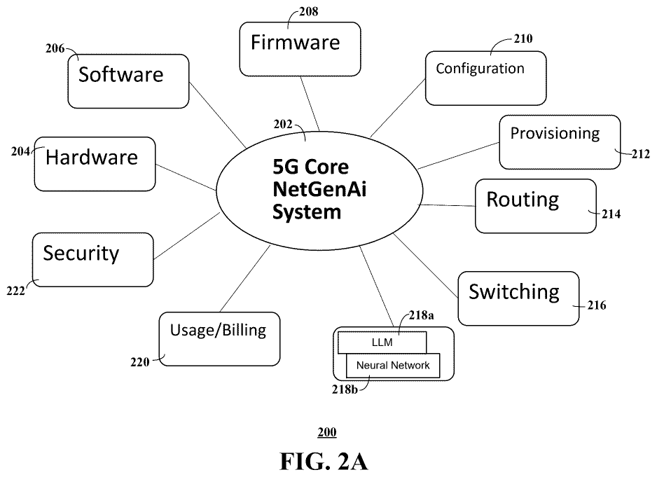

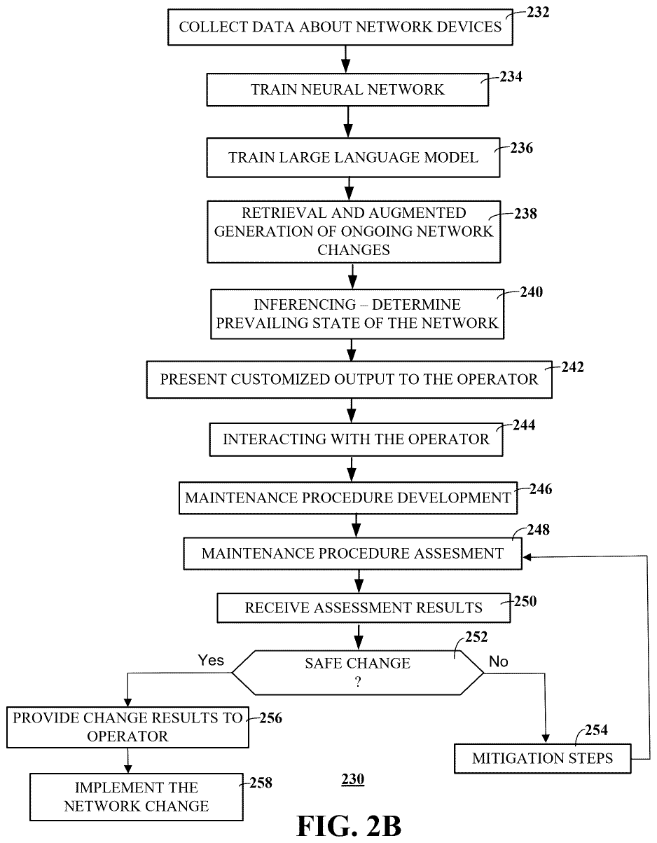

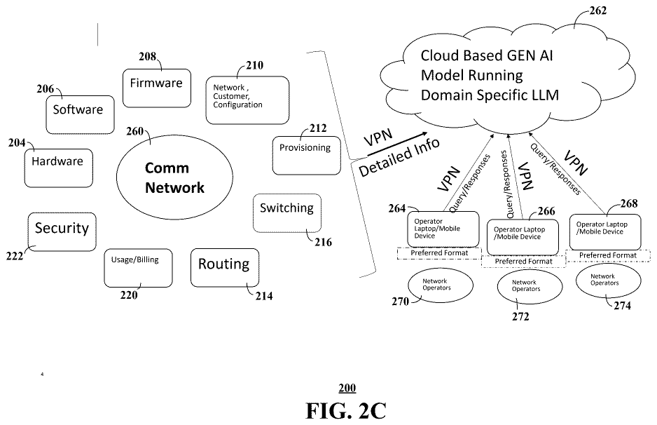

FIG. 2A is a block diagram illustrating an example, non-limiting embodiment of a system 200 functioning within the communication network of FIG. 1 in accordance with various aspects described herein. FIG. 2A illustrates in exemplary form a system that may be referred to as the 5G Core NetGenAi system 202, which is designed to automate and streamline maintenance and upgrade processes within the communications network 125 depicted in FIG. 1. The system 202 integrates various layers of network information, including hardware layer 204, software layer 206, firmware layer 208, configuration layer 210, provisioning layer 212, routing layer 214, switching layer 216, artificial intelligence/machine learning (AI/ML) layer 218, usage/billing layer 220 and security layer 222. By leveraging detailed network data from these layers, the system can simulate network modifications, assess their impacts, and provide recommendations to ensure stable and secure operations. This reduces the manual effort required by network operators to assemble key information and prepare for the modification and minimizes the risk of unplanned outages, thereby enhancing the overall efficiency and reliability of the communications network.

The hardware layer 204 includes detailed information about the physical components of the network, such as switches, routers, service endpoints such as base stations in a mobile platform, and individual components such as hardware chassis, interface cards, small form-factor pluggables (SFPs), disks, random access memory (RAM), and central processing units (CPUs). The hardware layer 204 encompasses network devices and connectivity links and associated operating information, as well as location data, which are critical for understanding the physical topology and capabilities of the network. At times, for maintenance and for system upgrades, some hardware components of the hardware layer 204 may need to be taken offline for a time for maintenance and replaced and new hardware components may be added.

The software layer 206 contains information about the applications, operating systems and software agents running on the network devices, such as software-defined networking (SDN) agents and operations, administration, and maintenance (OAM) agents. The software layer 206 includes setup and operating information that is essential for managing and configuring behavior of network elements and, through that, the state of the network. At times, for maintenance and for system upgrades, some software components of the software layer 206 may be reconfigured, taken offline, replaced or upgraded.

The firmware layer 208 includes data about the firmware components, such as basic input/output system (BIOS) and network controller firmware. The firmware layer 208 provides setup and operating information that is crucial for ensuring the proper functioning of the hardware components. The firmware layer 208 may require maintenance and upgrading at times.

The configuration layer 210 involves operator-provided configurations for the control and data planes of the network devices. The configuration layer 210 includes detailed configuration settings that define how the network devices operate and interact with each other. The provisioning layer 212 contains customer-specific setup and configuration information for customers who subscribe to services in the network. Such subscriptions may be for access to a mobility network such as wireless access 120 or to broadband services such as broadband access 110 (FIG. 1). The provisioning layer 212 includes data about how customer services are provisioned and managed within the network, ensuring that customer requirements are met. Provisioning information relates to specific service features to which the customer has access as well as information about customer equipment, etc.

The routing layer 214 includes routing operating and setup information. The routing layer 214 provides details about the routing protocols and configurations used to direct traffic within the network, ensuring efficient and reliable data transmission. The switching layer 216 contains information about the switching operations and setup in the communications network. The switching layer 216 includes data about the switching protocols and configurations that manage the flow of data between different network segments such as between wireless access 120 and broadband access 110 illustrated in FIG. 1.

The AI/ML layer 218 includes tools for implementing artificial intelligence and machine learning functions in support of the other elements of the system 200. In the illustrated example, the AI/ML layer 218 includes a large language model (LLM) 218a and a neural network 218b.

The usage/billing layer 220 contains critical counters and resource usage measurements related to services provided to service subscribers in the network. It includes data about network usage and billing information, which is essential for managing network resources and ensuring accurate billing for services provided. The security layer 222 includes security-related policies, configurations and operating information. The security layer 222 encompasses data about security policies, access controls, and other measures implemented to protect the network from threats and unauthorized access.

The system 202 learns the design and operation of the communications network, most importantly data flows, by training a neural network such as the neural network 218b on the detailed information from these layers. When a network operator proposes a modification to the network, the system receives this proposed modification and simulates its implementation. The system then evaluates the results of the modification for any error conditions impacting data flows that may arise. If error conditions are identified, the system determines the necessary corrections to address these issues. Finally, the results, including any identified corrections, are presented to a network operator or other personnel in a manner that the network operator can best understand and approve for implementation, ensuring clear communication and safe implementation of network changes. This comprehensive approach significantly reduces the manual effort required by network operators to assemble key information and prepare for the modification and minimizes the risk of unplanned outages or disruptions, thereby enhancing the overall efficiency and reliability of the communications network.

FIG. 2B depicts an illustrative embodiment of a method 230 in accordance with various aspects described herein. The method 230 may be implemented in a suitable device associated with or part of a communication network such as the communications network of FIG. 1. The device should have access to information about other components of the communication network or at least a slice of the communication network being evaluated, maintained or upgraded. The method 230 may be initiated by any suitable operation, such as by network operators seeking to maintain or upgrade or otherwise modify some aspect of the communication network.

In a first example embodiment, a component of the network is due for maintenance in a procedure that will require taking the component offline, as well as disabling other adjacent portions of the communication network. The maintenance procedure must be planned carefully before execution to ensure that no disruption to customer data flows will occur during or as a result of the maintenance operation. In a second example, a component of the network is to be upgraded, which may include replacement with a substitute component or with a component that adds additional features and may expand the network in some way. Again, the upgrade procedure much be planned carefully before execution to ensure no disruption including no disruptions of any data flows.

FIG. 2B illustrates method 230 for implementing a system such as the 5G Core NetGenAi system 202 within the communications network 125 depicted in FIG. 1 and described in connection with FIG. 2A. The method 230 begins with step 232, where data about network devices is collected. This data includes detailed information from various layers such as hardware layer 204, software layer 206, firmware layer 208, configuration layer 210, provisioning layer 212, routing layer 214, switching layer 216, AI/ML layer 218 (which could be implemented as a private instance or running on a public cloud), usage/billing layer 220 and connectivity links layer and security layer 222, as shown in FIG. 2A. This comprehensive data collection ensures that the system has a complete and accurate view of the network's current state. The process of step 232 may be an ongoing process to collect such information over time as the network is operating to convey customer traffic.

In step 234, the neural network 218b may be trained using the collected data to learn the design and operation of the communications network, including data flows. This training process involves adjusting the weights of the neural network to accurately represent the state of the network. By doing so, the neural network can effectively model the network's behavior and predict the impacts of any proposed modifications. In some embodiments, step 234 may include tuning the neural network 218b. Such tuning includes customizing a general LLM to understand domain-specific information and specific goals for the use case. In such embodiments, tuning may be performed first, followed by training the neural network 218b.

Next, in step 236, the large language model (LLM) 218a is trained. This LLM 218a may incorporate the tuned neural network and is domain-specific to the communications network. The training process involves using the detailed network data to configure the embedded neural network to reflect the current state of the communications network accurately. The LLM is trained to understand the specific terminology (which may be part of a tuning process) and operational characteristics of the communications network, ensuring that it can provide accurate and relevant responses to operator queries. In some embodiments, a general-purpose LLM may be selected and tuned make the LLM 218a domain-specific to the domain of the communication network.

Step 238 involves the retrieval and augmented generation of ongoing network changes. This step ensures that the LLM 218a stays updated with the latest information about the network's structure and function, allowing it to provide accurate and relevant responses. The retrieval augmented generation (RAG) approach allows the system to incorporate new data without the need for extensive retraining, making it more efficient and responsive to changes in the network.

In step 240, the LLM 218a performs inferencing to draw conclusions on the prevailing state of the network. This involves analyzing the current network data to provide information, identify and assess any changes or potential issues. The inferencing process allows the system to detect state changes, such as traffic flow, latency, security, connectivity, and performance, and alert operators to any potential problems.

The results of the inferencing are then presented to the operator in step 242. The output is customized by a machine language drive presentation application to the operator's preferences, ensuring that the information is presented in a manner that the network operator can rapidly assimilate key information as opposed to a manual and tedious process. This customization can include various formats such as audio responses, video responses, written descriptions, diagrams, and step-by-step instructions, as described in the claims.

In examples, the a Machine Learning based presentation application monitors the interactions with each respective operator over time to learn that operator's preferences for learning about the communication network. For example, one operator may prefer to see information presented as text displayed on a screen. A second operator may prefer graphs and charts highlighting certain features and relationships among the information. Each operator interacts with the LLM 118a by prompting the LLM 118a with queries. The queries are monitored by the LLM 118a and responses are provided to the operator. In addition, the queries are used by a machine learning based presentation application to customize responses and tailor the interaction with the operator based on their preferences for rapid assimilation of key information.

Step 244 involves interacting with the operator. The operator can provide feedback, ask questions, and request further information about the network state and proposed modifications. As noted, in some examples and in some respects, this may be by the operator interacting with the LLM 118a, submitting queries and receiving responses from the LLM 118a. This interactive session allows the operator to rapidly build a comprehensive understanding of the network slice they are working on and make informed decisions about the maintenance or upgrade activities.

In step 246, a maintenance procedure is developed based on the operator's input and the LLM's analysis. This procedure outlines the steps required to implement the proposed network modification or maintenance procedure safely. This procedure ensures that the maintenance procedure or network modification can be completed without any disruption to customers of the network. The system generates a detailed and thorough maintenance procedure that complies with the operator's requirements and guidelines.

The maintenance procedure is then assessed in step 248. The LLM 218a simulates the proposed modification and evaluates the results for any error conditions such as impact to prevailing data flows etc. This generative artificial intelligence-based simulation allows the system to identify any potential issues before the modification is implemented on the live network, reducing the risk of unplanned outages.

In step 250, the assessment results are received by the network operator. If, at step 252, the modification is deemed safe, the change results are provided to the operator in step 256, and the network change is implemented in step 258. The system ensures that the modification is applied to all involved elements in accordance with the established maintenance procedure, and pre-checks and post-checks are conducted to verify that the state of the network is preserved.

In some embodiments, a software defined network (SDN) may be used to implement the modification to the components of the communication network. For example, the SDN may be in data communication with the components involved in the modification and may operate to perform the maintenance or upgrade procedure. In one example, a router in a remote location needs to have software updated to a current software revision. The SDN, under control of method 230, controls switching equipment around the router of interest to route network traffic away from the router so that the router is taken offline. For example, routing tables of other switches and routers may be temporarily modified to remove the router of interest from receiving any traffic. With the router of interest functionally out of the network traffic plane, the SDN can communicate over a control plane with the router of interest to provide the required software for the update and initiate the update procedure. Following installation of the new software, a self-test procedure may be conducted to ensure proper functioning of the router of interest. With the software update complete, the router of interest is reinserted into the traffic plane of the network with restored configuration. This may be done, for example, by reversing the previous process of modifying routing tables. Further self-testing and in-network testing may be done to fully verify the operation of the upgraded router.

Each of the steps in this example, including taking the router out of the network, updating the software, and reinserting the router into the network, has been designed by the neural network 218b working with the operator based on the knowledge accumulated including the data received at step 232. The neural network 218b initiates the necessary control signals for the switches and other components around the router of interest and for the router itself. The SDN is used to communicate these control signals to the components. The LLM 218a may interact with the SDN to control the process and to provide information to the network operator. The combined working of the neural network of the neural network 218b, the LLM 218a, the network operator, and the SDN ensure a safe change to the network, meaning that no disruption to any customer or any data flow in the network will occur during or as a result of the change.

If the modification is not safe based on the assessment of step 248, mitigation steps are identified in step 254 to address the error conditions. The system provides recommendations to the operator for mitigating any undesirable impacts, allowing for rapid troubleshooting and iterative revisions of the maintenance procedure. In one example, the assessment may determine that one data flow from a customer may be interrupted during the implementation of the change. The mitigation steps 254 may include specifying a different process flow for making the change. In another example, one hardware component is to be replaced by another but operation of the two is not fully compatible. The neural network 218b identifies the incompatibility. The incompatibility may mean that some functionality may be lost if the planned implementation is made. Instead, the modification steps 254 may include selecting a different component, even a different model of component for the substitute that will be more fully compatible with the component being replaced.

The method 230 may iterate through step 248, step 250, step 252 and step 254. This iterative process ensures that a safe and effective change procedure is developed and implemented by the method 230.

This comprehensive approach, as illustrated in FIG. 2B, links the detailed network data from FIG. 2A and the network elements from FIG. 1 to provide a streamlined and automated process for network maintenance and upgrades. By leveraging the capabilities of the 5G Core NetGenAi system 202, the method 230 significantly reduces the manual effort required by network operators and minimizes the risk of unplanned outages, thereby enhancing the overall efficiency and reliability of the communications network.

The various embodiments describe a device, a non-transitory machine-readable medium, and a method for simulating and implementing network modifications in a communications network. The method 230 of FIG. 2B can be adapted to these embodiments as follows.

The device includes a processing system with a processor and a memory that stores executable instructions. These instructions facilitate operations such as collecting data about the communications network, tuning a large language model (LLM) that incorporates the neural network to be domain specific to a communications network, to help with rapid operator training and generating safe maintenance procedures, training a neural network to represent the state of the network, and training a large language model (LLM) that incorporates the neural network. The device receives a proposed network modification from a network operator and simulates the modification. It then evaluates the results for error conditions such as disrupted data flows, security vulnerabilities etc., and identifies necessary corrections. If the modification is safe, the device provides the simulated change results to the operator and implements the network change with operator confirmation.

In one embodiment, the device also receives information about the state of network elements and trains the LLM based on this information. The information includes details about hardware, software, firmware components, usage, billing, and customer configuration. The training of the LLM involves configuring the neural network with the state information of the network elements and connectivity fabric. The device simulates the network modification and assesses for impact. It identifies a proposed network modification and generates queries to the LLM to assess possible network impacts before implementation. The device receives information about ongoing changes to the network structure or function and incorporates this information into the LLM using a retrieval augmented generation approach. The device identifies operator preferences using machine learning and adapts query responses for rapid assimilation of network information by the network operators. The device adapts the presentation of responses based on the operator's identity and preferences, facilitating rapid knowledge acquisition. The adapted presentation format can include audio responses, video responses, written descriptions, diagrams, and step-by-step instructions.

The non-transitory machine-readable medium includes executable instructions that, when executed by a processing system, facilitate operations such as collecting data about the communications network, training a neural network, and simulating a network modification. The medium also assesses the result of the modification and implements the modification based on the simulation result with operator confirmation. In one embodiment, the medium receives an indication from the LLM that the network modification yields an unstable network state. The medium receives remediation steps from the LLM to yield a safe modification and implements the modification, including the remediation steps with operator confirmation. The medium updates the LLM with information about changes to the network structure or function. The medium identifies operator preferences using a machine learning application and adapts query responses based on these preferences, facilitating rapid information assimilation.

The method includes receiving data about the communications network, adjusting the weights of a neural network to represent the state of the network, and simulating a proposed network modification in an LLM incorporating the neural network. The method also involves receiving a simulation result for the proposed modification. In one embodiment, the method includes receiving an indication from the LLM that the proposed modification yields an unstable network state. The method includes receiving remediation steps from the LLM to produce a safe modification. The method involves communicating interactions between a network operator and the LLM, including receiving queries from the operator, forwarding them to the LLM, receiving query results, and forwarding them to the operator in a machine language application customized presentation. The method includes LLM training using received data about network security, network and customer configuration, routing, links, and devices.

In addition to the above embodiments, different types of artificial intelligence and machine learning techniques can be applied to the subject disclosure. For instance, the system can employ support vector machines (SVMs) to classify network states and predict the impact of modifications. Bayesian networks can be used to model the probabilistic relationships between different network elements and their states. Decision trees can help in identifying the best course of action based on the current network conditions. Neural networks, including deep learning models, can be used to learn complex patterns and behaviors within the network. Fuzzy logic models can handle uncertainties and provide more flexible decision-making processes. Reinforcement learning can be applied to optimize network performance by learning from the outcomes of previous modifications. These AI and machine learning techniques enhance the system's ability to automate and streamline network maintenance and upgrades, ensuring that modifications are thoroughly assessed and implemented safely.

By adapting method 230 of FIG. 2B to these embodiments, the system can effectively automate and streamline the process of network maintenance and upgrades. This comprehensive approach ensures that network modifications are thoroughly assessed and implemented safely, reducing the manual and error prone effort required by network operators and minimizing the risk of unplanned outages.

The subject disclosure can be adapted to various alternate embodiments in view of FIG. 1, FIG. 2A, FIG. 2B, and the described embodiments. One alternate embodiment could involve the integration of real-time monitoring and feedback mechanisms. The system could continuously monitor the network's performance and provide real-time feedback to the operators. This would allow for immediate detection and correction of any issues that arise during the implementation of network modifications. The real-time feedback could be presented through a user-friendly interface that includes visualizations, alerts, and detailed reports.

Additionally, the system could be adapted to support multi-tenant environments. In such an embodiment, a system such as the NetGenAi system could manage and maintain multiple shared network slices used by different tenants, such as enterprises, service providers, college campuses, and government agencies. Each tenant could have customized configurations, security policies, and performance requirements. The system would ensure that modifications to one tenant's configuration of any network slice do not adversely affect any other tenants'traffic flows.

The system could also be extended to include predictive maintenance capabilities. By analyzing historical data and identifying patterns, the system could predict potential issues before they occur and recommend proactive maintenance actions. This would help in preventing outages and ensuring continuous network performance.

Another embodiment could involve the use of blockchain technology to enhance the security and transparency of the network modification process. Each modification and its associated data could be recorded on a blockchain, providing an immutable and auditable record of all changes. This would ensure accountability and trust in the network management process.

Furthermore, the system could be integrated with external data sources and services. For example, it could leverage all maintenance work planned, weather data, traffic data, and other external factors that might impact network performance. By incorporating this additional information, the system could provide more accurate assessments and recommendations including the best time for the maintenance work to happen, resolving any conflicts with other maintenance work planned, and derisking based on events.

In another embodiment, the system could support collaborative workflows. Multiple operators and engineers could work together on the same network modification project, sharing information and insights through a collaborative platform. This would enhance teamwork and ensure that all aspects of the modification are thoroughly considered.

The system could also be adapted to support different types of networks, such as IP core and access, internet of things (IOT), edge compute cloud, fourth generation cellular (4G) core and access networks, fifth generation cellular (5G) core and access networks, and beyond. The LLM could be trained to handle the specific requirements and characteristics of each network type, ensuring that the assessment and modifications are optimized for the particular network technology.

Lastly, the system could include advanced visualization tools to help operators understand the network's state and the impact of modifications. These tools could include three dimensional (3D) models, interactive dashboards, and simulation environments that allow operators to explore different scenarios and outcomes. A machine learning based presentation application customizes how information is presented based on each operator's preference for rapid assimilation of network information.

By adapting method 230 of FIG. 2B to these alternate embodiments, the system can effectively automate and streamline the process of network maintenance and upgrades. This comprehensive approach ensures that network modifications are thoroughly assessed and implemented safely, reducing the manual effort required by network operators and minimizing the risk of unplanned outages.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C is a block diagram illustrating an example, non-limiting embodiment of a system functioning within the communication network of FIG. 1 in accordance with various aspects described herein.

FIG. 2C illustrates the integration of the system 202 within a communications network 260, leveraging a cloud-based AI model running a domain-specific large language model (LLM) 262. The communications network 260 includes various layers of network information, such as hardware 204, software 206, firmware 208, configuration 210, provisioning layer 212, routing layer 214, switching layer 216, security layer 222, and usage/billing layer 220, as depicted in FIG. 2A. This detailed network information is collected and sent to the cloud-based AI model 262 via a virtual private network (VPN) for secure transmission.

The cloud-based AI model 262 processes the detailed network information and performs inferencing to determine the prevailing state of the network, as described in step 240 of method 230 illustrated in FIG. 2B, for example. The AI model 262 can simulate network modifications, assess their impacts, and provide recommendations. The results and recommendations are then returned to the network operators'devices, such as laptops or mobile devices 264, 266, and 268, also via VPN.

The network operators 270, 272, and 274 interact with the AI model 262 through their devices, receiving customized outputs in their preferred formats, which can include audio responses, video responses, written descriptions, diagrams, and step-by-step instructions, as described in step 242 of method 230 illustrated in FIG. 2B. This interaction allows operators to provide feedback, ask questions, and request further information about the network state and proposed modifications, as described in step 244 of FIG. 2B.

By integrating the cloud-based AI model 262 with the communications network 260, the system can automate and streamline the process of network maintenance and upgrades. This comprehensive approach ensures that network modifications are thoroughly assessed and implemented safely, reducing the manual effort required by network operators and minimizing the risk of unplanned outages, thereby enhancing the overall efficiency and reliability of the communications network.

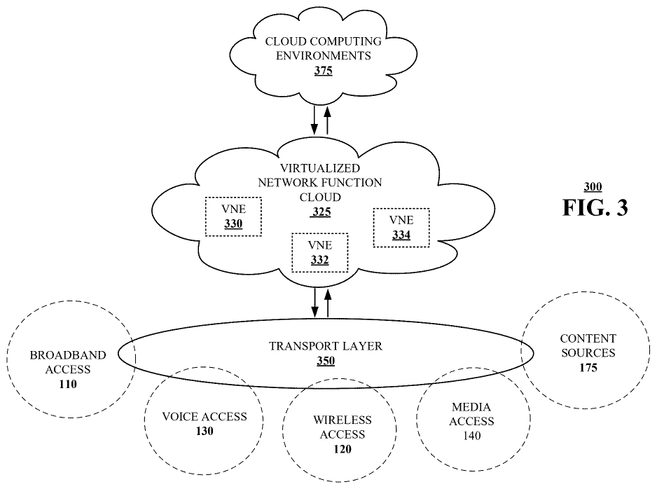

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 230 presented in FIG. 1, FIG. 2A, FIG. 2B, and FIG. 3. For example, virtualized communication network 300 can facilitate in whole or in part using a neural network and a large language model to simulate network modifications, assess their impacts, and provide recommendations, ensuring stable and secure operations.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

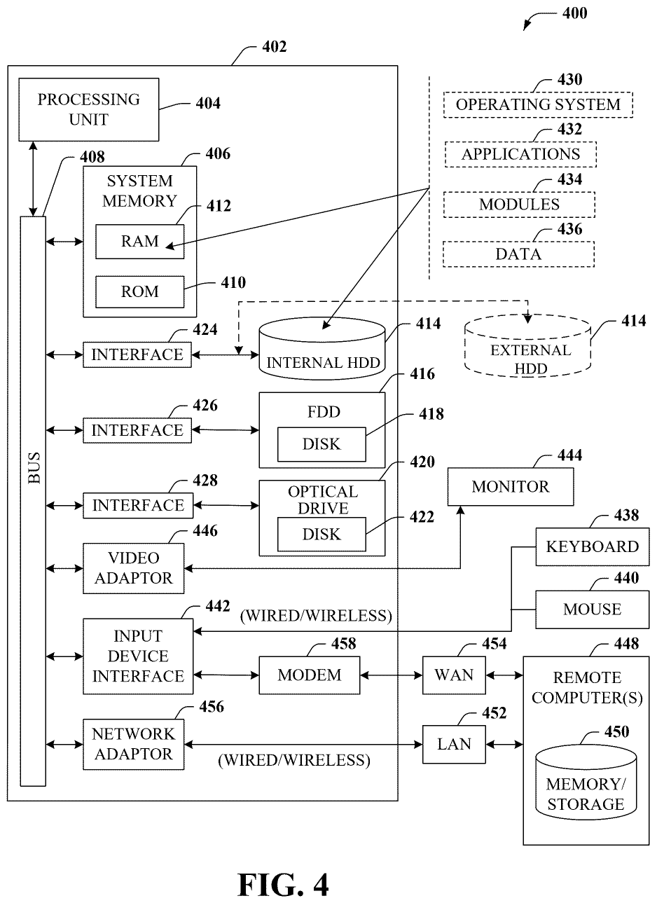

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part using a neural network and a large language model to simulate network modifications, assess their impacts, and provide recommendations, ensuring stable and secure operations.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

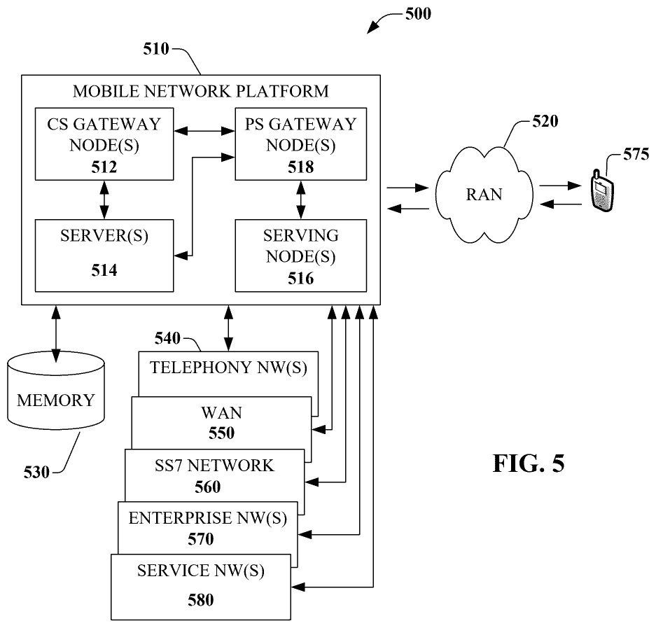

Turning now to FIG. 5, an embodiment 500 of a mobile network platform 510 is shown that is an example of network elements 150, 152, 154, 156, and/or VNEs 330, 332, 334, etc. In embodiments, for example, a generative AI LLM model and contained neural network could be run on a public cloud infrastructure such as cloud based AI model 262 (FIG. 2C) or a private cloud infrastructure or operator premise-based compute servers to simulate network modifications, assess their impacts, and provide recommendations, ensuring stable and secure operations. In one or more embodiments, the mobile network platform 510 can generate and receive signals transmitted and received by base stations or access points such as base station or access point 122. Generally, mobile network platform 510 can comprise components, e.g., nodes, gateways, interfaces, cloud infrastructure, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

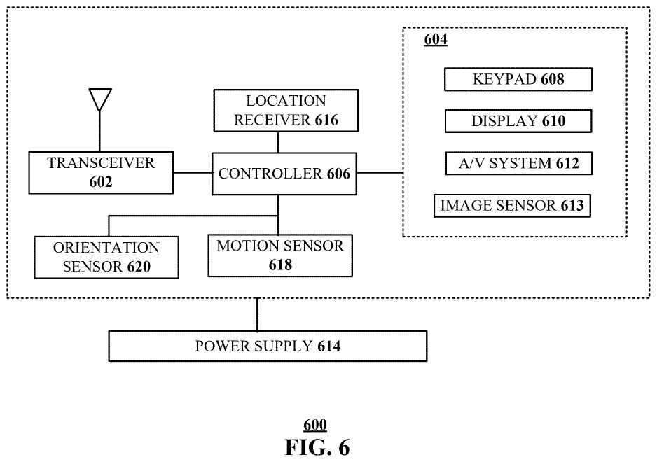

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed cloud-based computing environments where tasks are performed by remote processing devices that are linked through a communications network; however, some if not all aspects of the subject disclosure can be practiced on stand-alone computers. In a distributed cloud-based computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers and/or run in the cloud compute servers. In addition, these components can execute from various computer readable media having various data structures stored thereon. The components may communicate via local and/or remote processes such as in accordance with a signal having one or more data packets (e.g., data from one component interacting with another component in a local system, distributed cloud-based system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, cloud compute platform public or private, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to a Graphics Processing Unit (GPU), Tensor Processing Unit (TPU), an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving data about communications networks;
based on the data about the communication networks, adjusting weights of a neural network to represent a state of the communications networks;
training a large language model, the large language model incorporating the neural network, the large language model being selected to be domain specific to the communications networks;
providing, to the large language model, a network modification for simulation, wherein the network modification comprises one or more changes to the communications networks to modify structure or function of the communications networks;
receiving, from the large language model, an indication that the network modification yields a stable network state when the network modification is applied to the communications networks; and
providing, to the large language model, an approval of an implementation of the network modification, wherein the approval of the implementation of the network modification causes the large language model to automatically modify one or more components of the communications networks at a selected time to implement the network modification.

2. The device of claim 1, wherein the operations further comprise:
receiving information about a state of network elements of the communications networks; and
training the large language model based on the information about the state of the network elements of the communications networks.

3. The device of claim 2, wherein the receiving information about the state of the network elements of the communications networks comprises:
receiving information about hardware, software and firmware components of the communications networks;
receiving information about usage and billing in the communications networks; and
receiving information about network configuration and customer specific configuration of the communications networks.

4. The device of claim 3, wherein the training the large language model comprises:
providing the information about the state of the network elements of the communications networks to configure the neural network incorporated in the large language model.

5. The device of claim 1, wherein the operations further comprise:
simulating, by the large language model, the network modification; and
assessing impact of the network modification.

6. The device of claim 1, wherein the operations further comprise:
identifying a proposed network modification to the communications networks; and
generating queries to the large language model, the queries prompting the large language model to provide responses, wherein the queries assess possible network impacts of the proposed network modification before actually implementing the network modification on the communications networks with operator confirmation.

7. The device of claim 1, wherein the operations further comprise:
receiving information about ongoing changes of a structure or a function of the communications networks; and
incorporating into the large language model the information about ongoing changes to the structure or the function of the communications networks using a retrieval augmented generation approach, so that the large language model can stay fully updated on the state of the communications networks.

8. The device of claim 1, wherein the operations further comprise:
identifying, based on machine learning, operator preferences of a network operator; and
adapting query responses of the large language model to the operator preferences of the network operator.

9. The device of claim 8, wherein the adapting the query responses of the large language model comprises:
receiving one or more queries from a particular network operator, the queries pertaining to structure and function of the communications networks; and
adapting presentation of responses to the one or more queries according to preferences of the particular network operator, thereby facilitating accelerated knowledge acquisition.

10. The device of claim 9, wherein the adapting presentation of responses by the large language model comprises:
selecting, based on identity of the particular network operator, a format for the responses to the one or more queries, forming a selected format, wherein the selected format for the responses comprises one or more of audio responses, video response, written description responses, diagrams and step by step instructions.

11. A non-transitory machine-readable medium, comprising executable instructions that, when executed by a processing system including a processor, facilitate performance of operations, the operations comprising:
receiving data about a communications network;
based on the data about the communication network, adjusting weights of a neural network to represent a state of the communications network;
simulating, by a large language model, a network modification, wherein the network modification comprises one or more changes to the communications network to modify structure or function of the communications network;
assessing impact of the network modification;
receiving, from the large language model, a simulation result based on the simulating the network modification; and
implementing the network modification to the communication network based on the simulation result with operator confirmation.

12. The non-transitory machine-readable medium of claim 11, wherein the operations further comprise:
receiving, from the large language model, an indication that the network modification yields a stable network state when the network modification is implemented to the communications network.

13. The non-transitory machine-readable medium of claim 11, wherein the operations further comprise:
receiving, from the large language model, remediation steps to yield a safe modification to the communications network; and
implementing the network modification, including the remediation steps, to the communication network.

14. The non-transitory machine-readable medium of claim 11, wherein the operations further comprise:
updating the large language model with information about ongoing changes to structure or function of the communications network so that the large language model can remain fully updated on the state of the communication networks.

15. The non-transitory machine-readable medium of claim 11, wherein the operations further comprise:
identifying, based on machine learning, operator preferences of a network operator; and
adapting query responses of the large language model to the operator preferences of the network operator.

16. A method, comprising:
receiving, by a processing system including a processor, data about a communications network, wherein in the data about the communications network includes information about structure of the communications network and function of the communications network;
adjusting, by the processing system, weights of a neural network to represent a state of the communications network, wherein the adjusting the weights of the neural network is based on the data about the communication network;
simulating, by the processing system, in a large language model incorporating the neural network, a proposed network modification to the communications network; and
receiving, by the processing system, a simulation impact of the proposed network modification.

17. The method of claim 16, wherein the receiving the simulation result comprises:
receiving, by the processing system, from the large language model, an indication that the proposed network modification yields a stable network state when the proposed network modification is applied to the communications network.

18. The method of claim 16, wherein the receiving the simulation result comprises:
receiving, by the processing system, from the large language model, remediation steps to vary the proposed network modification to yield a safe modification for the communication network.

19. The method of claim 18, wherein the receiving the remediation steps comprises:
communicating, by the processing system, an interaction between a network operator and the large language model, wherein the communicating the interaction comprises receiving queries from the network operator about a slice of the communications network undergoing change, forwarding the queries to the large language model, receiving query results from the large language model and forwarding the query results in a preferred format to the network operator.

20. The method of claim 16, wherein receiving the data about the communications network comprises:
receiving, by the processing system, information about network security of the communications network;
receiving, by the processing system, information about network elements and customer configuration in the communications network;
receiving, by the processing system, information about network routing in the communications network; and
receiving, by the processing system, information about network elements of the communications network.
